(19) United States
(12) Patent Application Publication
(10) Pub. No.: US 2019/0102138 A1
(43) Pub. Date: Apr. 4, 2019

(54) METHOD FOR PREVENTING DEROGATORY LYRICS IN A SONG FROM BEING PLAYED AND SYSTEM

(71) Applicant: Paulo Jorge Valdez, Langley (CA)

(72) Inventor: Paulo Jorge Valdez, Langley (CA)

(21) Appl. No.: 15/721,536

(22) Filed: Sep. 29, 2017

(51) Int. Cl. G06F 3/16; G11B 20/10

(52) U.S. Cl. CPC G06F 3/162; G06Q 30/02; G06F 3/165; G11B 20/10

(57) ABSTRACT

A method for preventing derogatory lyrics in a song from being played and a system for recognizing derogatory lyrics in a song. It allows users to listen to music in front of all types of audiences without offensive lyrics being played. The method includes downloading a computing device application on a computing device; using a sensor to identify derogatory lyrics in music; omitting the derogatory lyrics; and producing a song with clean lyrics. The music may be received and played from a radio station, video channel, video music, or from the computing device application. The method may include the ability to skip through songs with inappropriate lyrics to a song with appropriate lyrics.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of mobile applications and more specifically relates to an audio filtering mobile application.

### 2. Description of Related Art

Lyrics are words that make up a song usually consisting of verses and choruses. The meaning of lyrics can either be explicit or implicit. Some lyrics are abstract, almost unintelligible, and, in such cases, their explication emphasizes form, articulation, meter, and symmetry of expression. Rappers can also create lyrics, often with a variation of rhyming words, that are meant to be spoken rhythmically rather than sung. Often, lyrics include inappropriate language. A suitable solution is desired to filter music for audiences.

U.S. Pat. No. 8,135,854 to Ted E. Dunning, et. al. relates to a controllable track-skipping. The described controllable track-skipping includes a method, system, and computer program product allow users to skip and/or to fast-forward through media items such as songs, while limiting the extent to which skipping is allowed in order to maintain conformance with sound performance complement restrictions such as those specified by the Digital Millennium Copyright Act. If the user requests a skip that may result in a DMCA violation, the skip is disallowed and the request is denied. Playlists are constructed so that the sound recording performance complement limitations are applied to a longer time period than the period specified in the DMCA, the longer time period being defined by adding an “excess time” to the normal DMCA period. If the user attempts to skip a song or song portion that would cause the aggregated skipped amount to exceed the excess time, the skip is disallowed.

### BRIEF SUMMARY OF THE INVENTION

In view of the foregoing disadvantages inherent in the known mobile applications art, the present disclosure provides a novel method for preventing derogatory lyrics in a song from being played and system therefor. The general purpose of the present disclosure, which will be described subsequently in greater detail, is to provide a lyric filtering mobile application for providing clean lyrics.

A method for preventing derogatory lyrics in a song from being played and system is disclosed herein. The method comprising the steps of: downloading a computing device application on a computing device; using a sensor to identify derogatory lyrics in music; omitting the derogatory lyrics; and producing a song with clean lyrics. The computing device may be a smart phone, a laptop, an iPAD, or other suitable computing device. The computing device application is configured to switch from an on-position to an off-position. The music may be played from a radio station, video channel, video music, or from the computing device application. The method may include the ability to skip through songs with inappropriate lyrics to a song with appropriate lyrics. The present invention allows users to listen to music in front of all types of audiences without offensive lyrics being played.

The method may include the steps of downloading a computing device application on a computing device; using a sensor to identify derogatory lyrics in music; omitting the derogatory lyrics; producing a song with clean lyrics.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a method for preventing derogatory lyrics in a song from being played and system, constructed and operative according to the teachings of the present disclosure.

FIG. 1A is a view of a system for recognizing derogatory lyrics in a song during an ‘in-use’ condition, according to an embodiment of the disclosure.

FIG. 1B is a view of the system for recognizing derogatory lyrics in a song of FIG. 1A, according to an embodiment of the present disclosure.

FIG. 2 is a view of a method for preventing derogatory lyrics in a song from being played FIG. 1A, according to an embodiment of the present disclosure.

FIG. 3 is a flow diagram illustrating a method of use for preventing derogatory lyrics in a song from being played according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to mobile applications and more particularly to a method for preventing derogatory lyrics in a song from being played and system as used to improve the filtering of audio via a mobile application.

Generally, the present invention is an app by download on the phone, iPod or any other device, when listen to music with bad lyrics, where kids are around or grandfathers are around, that will cut the bad lyrics to cut out, you can still play any song around kids or an event without to worries of anyone hearing them. The fiction is before the song even comes up or at beginning of the song with software it will allow to skip the song till gets the right song (good lyrics). Three options may be included: original, clean, and skip. The original option plays a song without any changes being made. The clean option sensors bad language out of a song while allowing the song to play without interruption. The song will continue playing without replacement words or loud noise when an inappropriate word is recognized. The skip option skips the entire song. A sensor will recognize the song and move on to the next song. All three options come with on and off options for user manipulation.

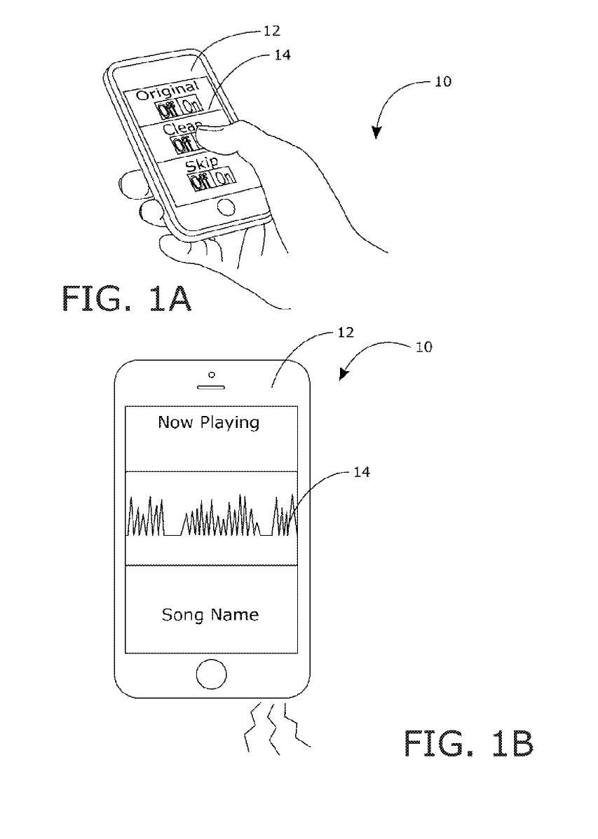

Referring now more specifically to the drawings by numerals of reference, there is shown in FIGS. 1A-3, various views of a system for recognizing derogatory lyrics in a song 10. FIG. 1A and 1B show views of the system for recognizing derogatory lyrics in a song 10 during an ‘in-use’ condition, according to an embodiment of the present disclosure. As illustrated, the system for recognizing derogatory lyrics in a song 10 comprises a computing device 12; a computing device application 14 in communication with the computing device 12; and a software for recognizing derogatory lyrics in a song, the software being supported by the computing device application 14. Songs may be added to the computing device application 14 to clean up the lyrics. The computing device 12 may be a smart phone, a laptop, an iPAD, or other suitable device. The computing device application 14 is activated when receiving the song. The computing device application 14 is configured to analyze the song and skip over derogatory lyrics. The music may be played from a radio station, video channel, video music, or from the computing device application 14.

A system for recognizing derogatory lyrics in a song 10 and method for preventing the derogatory lyrics from being played is disclosed, the method comprising: providing a system for recognizing derogatory lyrics in a song, comprising: a computing device 12; a computing device application 14 in communication with the computing device 12; and a software for recognizing derogatory lyrics in a song, the software being supported by the computing device application 14. The computing device 12 may be a smart phone, a laptop, an iPAD, or other suitable device. The computing device application 14 is activated when receiving the song. The computing device application 14 is configured to analyze the song and skip over derogatory lyrics. The music is played from a radio station. The music is played from a video channel The music is played from the computing device application 14.

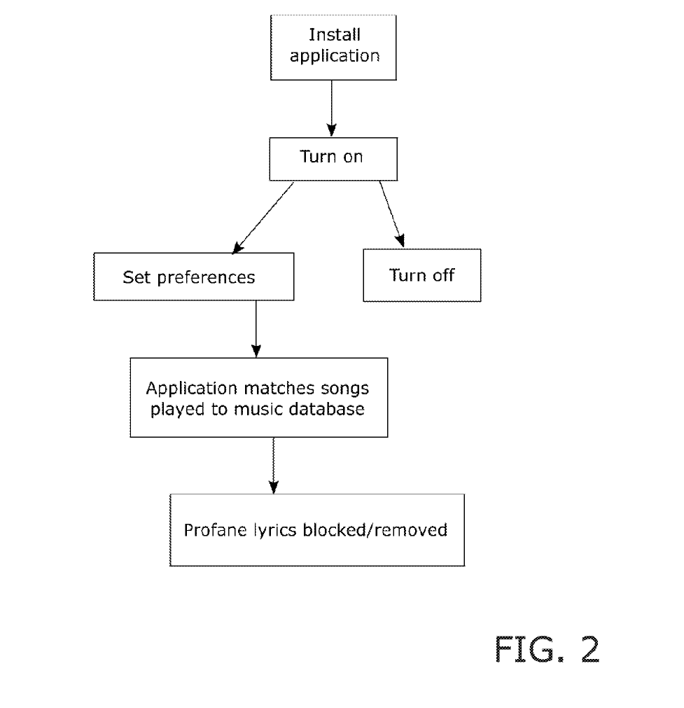

FIG. 2 shows a view of the method for preventing derogatory lyrics in a song from being played and system 500 of FIG. 1A, according to an embodiment of the present disclosure. As above, the method for preventing derogatory lyrics in a song from being played and system 10 may comprise the steps of: downloading a computing device application 14 on a computing device 12; using a sensor to identify derogatory lyrics in music; omitting the derogatory lyrics; and producing a song with clean lyrics. The computing device 12 may be a smart phone, a laptop, an iPAD, or other suitable computing device. The computing device application 14 is configured to switch from an on-position to an off-position. The music may be played from a radio station, video channel, video music, or from the computing device application 14. The method may include the ability to skip through songs with inappropriate lyrics to a song with appropriate lyrics. The present invention allows users to listen to music in front of all types of audiences without offensive lyrics being played.

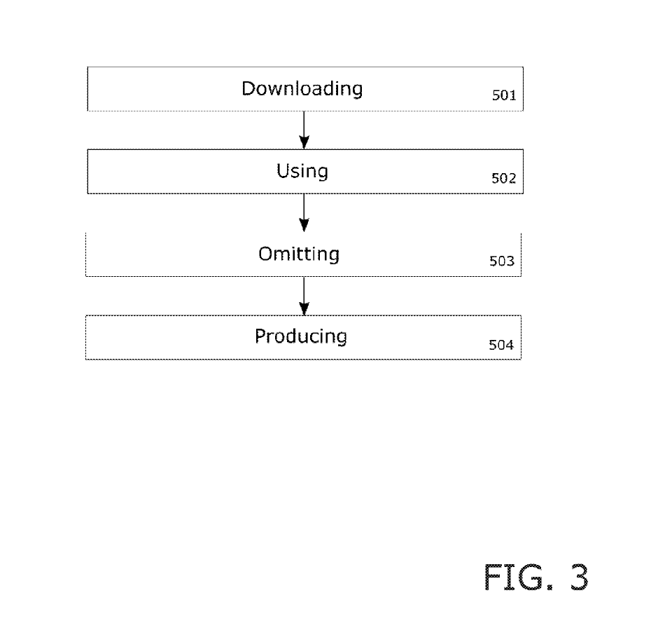

FIG. 3 shows a flow diagram illustrating a method for preventing derogatory lyrics in a song from being played and system 500, according to an embodiment of the present disclosure. In particular, the method for preventing derogatory lyrics in a song from being played 500 may include one or more components or features of the system for recognizing derogatory lyrics in a song 10 as described above. As illustrated, the method for preventing derogatory lyrics in a song from being played 500 may include the steps of: step one 501, downloading a computing device application 14 on a computing device; step two 502, using a sensor to identify derogatory lyrics in music; step three 503, omitting the derogatory lyrics; and step four 504, producing a song with clean lyrics.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for preventing derogatory lyrics in a song from being played [NOTE: e.g., different step orders within above-mentioned list, elimination or addition of certain steps, including or excluding certain maintenance steps, etc.], are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A method for preventing derogatory lyrics within a song from being played, said method comprising the steps of:
downloading a computing device application on a computing device;
using a sensor to identify derogatory lyrics in music;
skipping said derogatory lyrics within the song while allowing the song to play without interruption and without replacing the derogatory lyrics; and
producing a song with clean lyrics.

2. The method of claim 1, wherein said computing device is a smart phone.

3. The method of claim 1, wherein said computing device is a laptop.

4. The method of claim 1, wherein said computing device is an iPAD.

5. The method of claim 1, wherein said computing device application is configured to switch from an on-position to an off-position.

6. The method of claim 1, wherein said music is played from a radio station.

7. The method of claim 1, wherein said music is played from a video channel.

8. The method of claim 1, wherein said music is played from said computing device application.

9. A system for recognizing and skipping over derogatory lyrics within a song, said system comprising:
a computing device;
a computing device application in communication with said computing device, said computing device application configured to analyze said song and skip over derogatory lyrics within the song while allowing the song to play without interruption and without replacing the derogatory lyrics; and
a software for recognizing derogatory lyrics in a song, said software being supported by said computing device application.

10. The system of claim 9, wherein said computing device is a smart phone.

11. The system of claim 9, wherein said computing device is a laptop.

12. The system of claim 9, wherein said computing device is an iPAD.

13. The system of claim 9, wherein said computing device application is activated when receiving said song.

14. (canceled)

15. The system of claim 9, wherein said music is played from a radio station.

16. The system of claim 9, wherein said music is played from a video channel.

17. The system of claim 9, wherein said music is played from said computing device application

18. A system for recognizing derogatory lyrics within a song and method for preventing said derogatory lyrics from being played, the method comprising:
providing a system for recognizing derogatory lyrics in a song, comprising:
a computing device;
a computing device application in communication with said computing device; and
a software for recognizing derogatory lyrics in a song, said software being supported by said computing device application;
wherein said computing device is a smart phone;
wherein said computing device application is activated when receiving said song;
wherein said computing device application is configured to analyze said song and skip over derogatory lyrics within the song while allowing the song to play without interruption and without replacing the derogatory lyrics;
using a sensor to identify derogatory lyrics in music;
skipping said derogatory lyrics within the song while allowing the song to play without interruption and without replacing the derogatory lyrics;
producing a song with clean lyrics; and
wherein said computing device application is configured to switch from an on-position to an off-position.
